(19) United States
(12) Patent Application Publication
(10) Pub. No.: US 2018/0281876 A1
(43) Pub. Date: Oct. 4, 2018

(54) Aerodynamic System Comprising A Vortex Generator Supplied By Exhaust Gases

(71) Applicant: Compagnie Plastic Omnium, Lyon (FR)

(72) Inventors: Philippe Gilotte, Benonces (FR); Yoann Eulalie, Lyon (FR)

(21) Appl. No.: 15/765,100

(22) PCT Filed: Sep. 29, 2016
(86) PCT No.: PCT/FR2016/052491

§ 371 Date: Mar. 30, 2018

(30) Foreign Application Priority Data
Sep. 30, 2015 (FR) 1559265

(51) Int. Cl. B62D 37/02; F15D 1/00

(52) U.S. Cl. CPC B62D 37/02; F15D 1/00

(57) ABSTRACT

The invention relates to an aerodynamic system for a motor vehicle, which can be arranged close to at least one region of detachment of at least one bodywork element of a vehicle. The system includes at least one vortex generator which generates a vortex by creating a periodic air jet and is supplied by exhaust gases from an exhaust line outlet of the vehicle.

### FIELD OF THE INVENTION

The invention relates to an aerodynamic system for a motor vehicle.

### BACKGROUND OF THE INVENTION

Motor vehicles in motion are subjected to various forces which oppose their advancement. These forces are in particular the solid friction forces, due to the contact of the wheels with the ground, and the aerodynamic forces, due partly to friction of the air on the vehicle bodywork panels, and partly to the pressure exerted mainly on the front and rear of the vehicle.

At high speed, these aerodynamic forces become dominant with respect to the other forces and play a major role on the energy consumption of the vehicle. Some of the aerodynamic forces are generated by the depressions created by the detachments, the recirculations and the longitudinal vortices of the air at the rear of the vehicle

Motor vehicles are therefore generally fitted with aerodynamic systems designed to facilitate the flow of air near the vehicle bodywork parts, more precisely to avoid the turbulence which generates a loss of energy and therefore, higher energy consumption by the vehicle.

It is known that this turbulence can be generated in the regions of detachment marked by incidence breaks of vehicle bodywork parts. These breaks, also called trailing edges or detachment lines, correspond to breaks in the part shape (change of curve, projecting shape, end of part) leading to incidence breaks of the air flow relative to the panel. These regions of detachment generate, downstream, turbulent zones where a depression is created when the vehicle is moving. This turbulent zone comprises a shear layer and a main returning vortex.

Such zones are found in particular in the lower part of the rear bumper (at the centre and/or at the rear bumper end caps).

To improve the air flow in these turbulent zones, at the lower part of the rear bumper, an attempt can be made to refine or extend these trailing edges by adapting the shape of the bodywork part. Conventional systems consist mainly of spoilers placed in these zones at the rear of the vehicle.

However, such parts do not eliminate the turbulence completely, and are relatively aesthetically restricting. In addition, in lower part of the rear bumper, a spoiler provides only limited efficiency due to the fact that, unlike the rear upper part of the vehicle, the spoiler dimension towards the rear of the vehicle (along the X-axis of the vehicle) is restricted in the lower part.

Aerodynamic devices are also known, from document EP1740442B for example, which consist of one or more fins forming at least one vortex generator and generally arranged upstream of a detachment line of a bodywork element of the motor vehicle. These fins can generally be moved between a retracted position and a projecting position in which they act on the turbulent structures generated around the bodywork elements of the vehicle.

However, such devices are faced with problems of size, appearance and integration on the bodywork elements. For example, the fins must always be retracted under certain conditions, which requires complex technical solutions to move the fins.

In addition, there is not really an upstream lower limit layer of detachment in the lower part, unlike in the upper part. Consequently, use in the lower part of this type of system, dedicated to the upper part, has limited efficiency.

An aerodynamic system to limit losses in the shear layer is also known, from document EP 1 873 044 for example, without imposing special shapes on the bodywork parts. Such a system comprises electromechanical means arranged close to a region of detachment of the vehicle. These means are able to convert electricity into pressure waves in order to create an air jet. This jet reduces the structures produced in the shear layer and decreases the intensity of the vortex produced downstream.

However, such a solution requires very precise positioning to be efficient, and is difficult to adapt to different types of vehicle and/or to different vehicle driving speeds.

In addition, like the solution based on vortex generation, this solution requires an energy input.

### SUMMARY OF THE INVENTION

The invention aims to remedy these disadvantages by providing a more efficient aerodynamic system for the rear lower part, requiring no additional energy input to the vehicle, and without imposing special shapes on the bodywork parts.

Thus, the object of the invention relates to an aerodynamic system for a motor vehicle, which can be arranged close to at least one region of detachment of at least one bodywork element of a vehicle. The system comprises at least one vortex generator which generates a vortex by creating a periodic air jet, and is supplied by exhaust gases from an outlet of the exhaust line of the vehicle.

The system may further comprise one or more of the following characteristics, taken alone or in combination:
the vortex generator is a passive member;
the vortex generator is composed of static parts;
the vortex generator is a fluidic oscillator;
the vortex generator is supplied by the exhaust gases by means of an exhaust gas distributor adapted to be connected to the outlet of the exhaust line of said vehicle;
the exhaust gas distributor comprises a means of connection to the exhaust line, and a tubular member substantially perpendicular to the exhaust line when connected to said line, the tubular member being used to distribute over at least some of the width of the vehicle the exhaust gases from the exhaust line of the vehicle;
the tubular member is dimensioned to act as an exhaust pipe silencer;
the vortex generator is oriented so as to direct the periodic air jet towards the region of detachment;
the region of detachment generates a shear layer, and said vortex generator is oriented so as to direct the periodic air jet in or towards the shear layer;
the periodic air jet generates vortices, and said vortex generator is oriented so that the vortices move in a predefined direction towards the shear layer so as to propagate the vortices in or towards the shear layer;
the system comprises a bypass system used to evacuate the gases of the exhaust line without passing through the vortex generator;
the system comprises at least one opening adapted to entrain the subframe air by a venturi effect;
the bodywork element is a rear bumper.

The invention also relates to a motor vehicle equipped with an aerodynamic system according to the invention.

### BRIEF DESCRIPTION OF THE DRAWINGS

The invention will be better understood on reading the accompanying figures, which are given solely by way of example and not limiting in any way, in which:

FIG. 1 is a diagram illustrating the rear of a motor vehicle equipped with an aerodynamic system according to one embodiment of the invention.

FIG. 2 is a detail of FIG. 1, illustrating more precisely the aerodynamic system.

FIG. 3 is a diagram illustrating the rear of a motor vehicle equipped with an aerodynamic system according to another embodiment of the invention.

FIG. 4 is a detail of FIG. 1, illustrating more precisely the aerodynamic system.

FIG. 5 illustrates a geometry of a fluidic oscillator used in one embodiment.

### DETAILED DESCRIPTION OF THE INVENTION

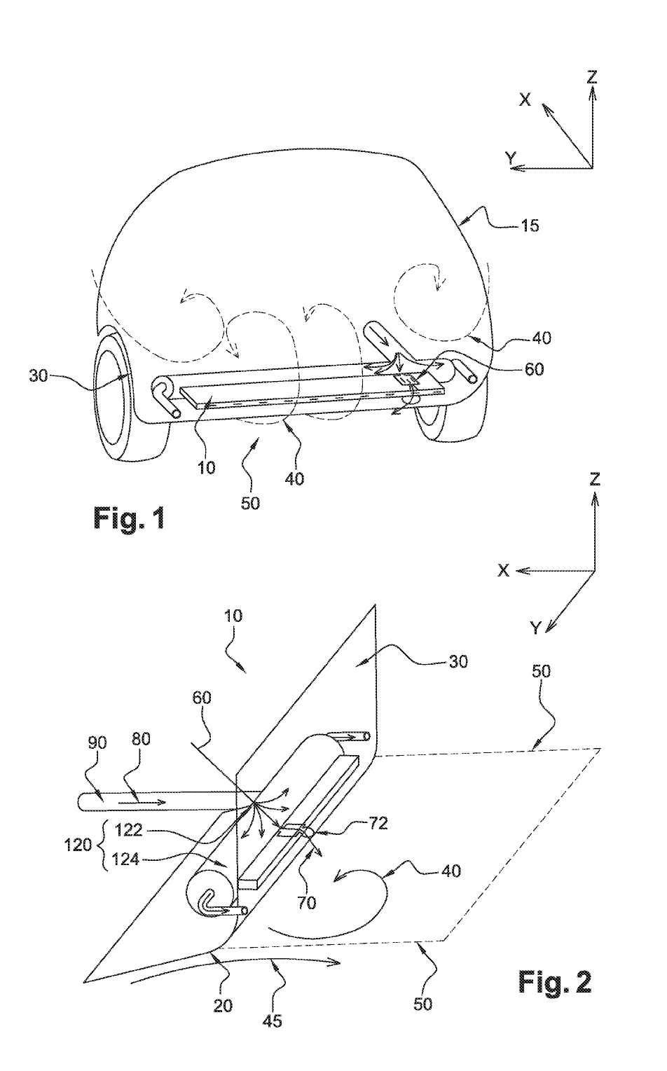

We now refer to FIG. 1, which illustrates the rear of a motor vehicle (15), equipped with an aerodynamic system (10) according to one embodiment of the invention, and to FIG. 2 which illustrates in detail this aerodynamic system (10) for a motor vehicle (15), as well as its operation.

This aerodynamic system (10) can be arranged close to (downstream or upstream) at least one region of detachment (20) of at least one bodywork element (30) of a vehicle. On the example of FIGS. 1 to 4, it is a vehicle rear bumper.

The region of detachment (20) generates downstream (in the direction of the air flow, i.e. from the front of the vehicle to the rear of the vehicle) a shear layer (50). This shear layer (50) represents an interface between two zones in which the air flows at different speeds:
a turbulent zone (40), at the rear of the vehicle, where the air flows slowly and creates an air depression;
a zone for circulation of the subframe air (45) or of the side air on the edges of the bodywork part (30), where the air flows more quickly.

The shear layer (50) is therefore on the periphery of the turbulent zone (40).

The aerodynamic system (10) comprises at least one vortex generator (60) which generates a vortex by creating a periodic air jet (70) and is supplied by exhaust gases (80) from the outlet of exhaust line (90) of the vehicle.

“Periodic air jets” means a set of jets which are generated with one or more given frequencies, and/or a jet whose speed and direction may vary according to their own frequencies.

Vortices (72) moving along the air jet (70) are generated around such air jets.

A periodic air jet can be created by blowing only, by sucking only, by blowing and sucking, or by oscillation, i.e. by varying the angle of orientation of a nozzle (we speak of a nozzle oscillating about a given position). Thus, the vortex generator (60) is adapted to periodically create an air jet by creating a succession of blowing, of sucking, or a periodic combination of blowing and sucking.

Different types of vortex generator can be used: a fluidic oscillator, a synthetic jet generator which generates a synthetic jet using a piezoelectric, electromagnetic, or electrostatic effect diaphragm, etc.

According to a preferred embodiment, the vortex generator (60) is a passive member, i.e. it transforms, with no energy input, the exhaust gases (80) from the outlet of the exhaust line (90) into periodic air jets. The vortex generator (60) uses the flow rate and pressure of the exhaust gases (80) to generate vortices.

To reduce noise nuisance, not only from the vortex generator (60), but also from the exhaust gas outlet, a vortex generator (60) composed solely of static parts is preferably used. Moving parts, even in a passive member, generate noise which it may be advantageous to reduce.

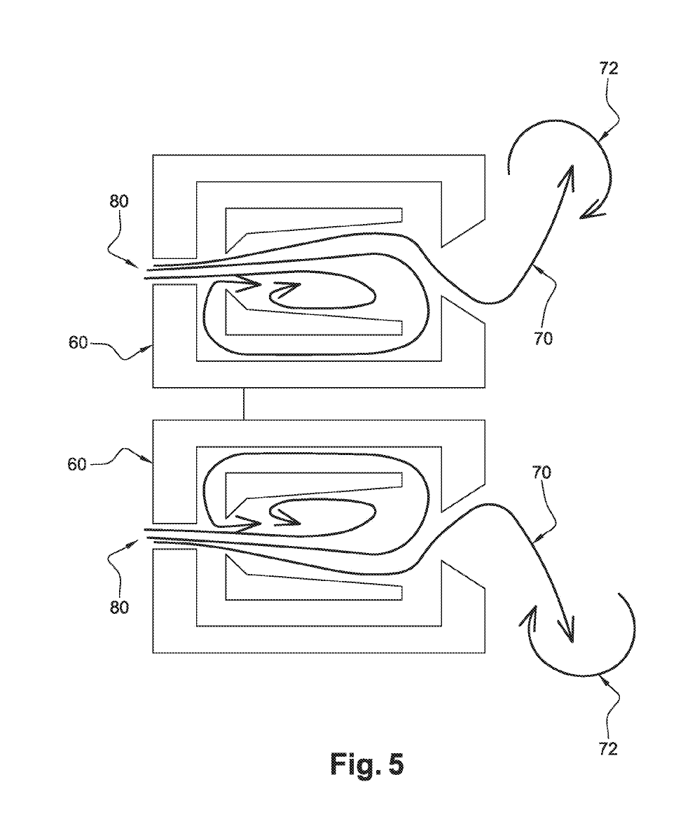

According to one embodiment, the vortex generator (60) comprises at least one fluidic oscillator used to generate a periodic air jet. A fluidic oscillator designates a member comprising an oscillation chamber, an air inlet into the chamber, and an air outlet from the chamber. The air leaving the oscillation chamber is a periodic jet of given period, also having a given flow rate and a given speed. The orientation of the jet leaving the oscillator varies over time, as illustrated on FIG. 5. The oscillation chamber comprises various walls adapted to make the incoming air jet oscillate by bouncing. Examples of such systems are described for example in the following document:
B. C. Bobusch et al. 2013 “Experimental study of the internal flow structures inside a fluidic oscillator”, Experiment in fluids, June 2013.

An example of the geometry of the oscillation chamber walls of a fluidic oscillator is shown on FIG. 5. The top figure illustrates the air flow of the oscillator at a time t1, and the bottom figure illustrates the air flow of this oscillator at another time t2.

The dimensions and geometry of the fluidic oscillator are defined according to various parameters:
the space available at the outlet of the exhaust line;
the speed of the periodic air jet;
the frequency of the periodic air jet;
the flow rate, pressure, temperature and speed of the exhaust gases.

The speed and frequency of the air jets are defined previously, by trial and error or preferably by modeling. Their values are chosen to maximize the pressure in the turbulent zone (40) of the region of detachment (20).

According to one embodiment, the vortex generator (60) is supplied by the exhaust gases by means of an exhaust gas distributor (120). Such a distributor (120) is adapted to be connected to the outlet of the exhaust line (90) of the vehicle, in a way known by specialists. The gases from the exhaust line (90) are thus collected entirely in the distributor (120).

According to the example of FIG. 2, the exhaust gas distributor (120) therefore comprises a means (122) for connection to the exhaust line (90), and preferably, a tubular member (124) substantially perpendicular to the exhaust line (90) when connected to said line (this member is thus oriented along the Y-axis of the vehicle). This tubular member (124) is used to distribute over at least some of the width of the vehicle the exhaust gases (80) from the exhaust line (90) of the vehicle.

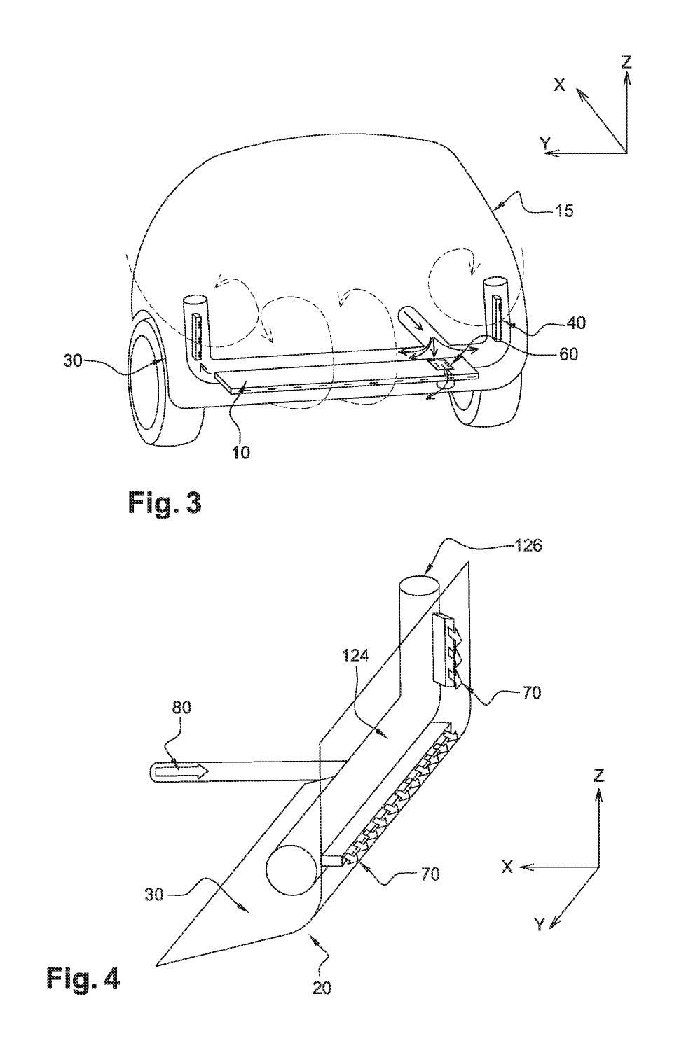

As illustrated on FIGS. 3 and 4, this tubular member (124) may also comprise at each end a tube (126) oriented vertically (along the Z-axis of the vehicle). These vertical tubes (126) are used to distribute the exhaust gases vertically over the sides of the vehicle (at the rear bumper end caps).

The tubular member (124) connected to the vortex generators (60) may in some applications be dimensioned to reduce the exhaust noise and in this case replace the exhaust pipe silencer.

According to the invention, the flow rate of the oscillating jets can be increased by using an opening in the exhaust line and/or in the distributor (120), entraining the subframe air (45) by a venturi effect produced by the flow of the exhaust gases. This opening can be positioned downstream or upstream from the fluidic oscillators. According to an example (opening positioned upstream), the exhaust line may comprise an opening, allowing the subframe air to be sucked then entrained by the exhaust gases inside the exhaust line, then in the distributor (120). According to an example (opening positioned downstream), the subframe air is entrained by the periodic air jets.

To further reduce the noise nuisance, wall shapes with no sharp edges are preferably used in the fluidic oscillator.

For some operating points of the vehicle, a cannula can be kept and a bypass system created, for example using a butterfly valve, if the back pressure generated by the oscillator is too high. The valve is controlled actively by the vehicle controller. This bypass is used to send the gases from the exhaust line directly to the rear of the vehicle without passing through the oscillators. This bypass can also be used to reduce the speed of the outlet gases or the oscillation frequency at a higher engine speed.

This bypass also allows the system to generate air jets with at least two different frequencies. One using directly the flow of air from the exhaust line modulated by the fluidic vortex generators (60); the other by actuating the butterfly valve of the bypass system, in order to create a fluctuating back pressure going back into the distributor (120) drawing the flow at the inlet of the vortex generators (60).

According to one embodiment, the aerodynamic system (10) can be oriented in a given direction, possibly adjustable according to the driving conditions, so as to direct the periodic air jets (70) towards the region of detachment (20).

Preferably, the aerodynamic system (10) can be oriented so as to direct the periodic air jets (70) in, or towards, the shear layer (50). Each periodic air jet (70) directed towards the rear of the vehicle, generates vortices (72) and the vortex generator (60) is oriented so that the vortices (72) move in a predefined direction towards the shear layer (50) so as to propagate the vortices in or towards the shear layer (50).

1. An aerodynamic system for a motor vehicle, which can be arranged close to at least one region of detachment of at least one bodywork element of the motor vehicle, wherein the system comprises at least one vortex generator which generates a vortex by creating a periodic air jet and is supplied by exhaust gases from an outlet of an exhaust line of the motor vehicle.

2. The system according to claim 1, wherein the vortex generator is a passive member.

3. The system according to claim 2, wherein the vortex generator is composed of static parts.

4. The system according to claim 3, wherein the vortex generator is a fluidic oscillator.

5. The system according to claim 1, wherein the vortex generator is supplied by the exhaust gases by an exhaust gas distributor adapted to be connected to the outlet of the exhaust line of said motor vehicle.

6. The system according to claim 5, wherein said exhaust gas distributor comprises a means of connection to the exhaust line, and a tubular member substantially perpendicular to the exhaust line when connected to said line, the tubular member being used to distribute over at least some of the width of the motor vehicle the exhaust gases from the exhaust line of the motor vehicle.

7. The system according to claim 6, wherein the tubular member is dimensioned to act as an exhaust pipe silencer.

8. The system according to claim 1, wherein said vortex generator is oriented so as to direct the periodic air jet towards the region of detachment.

9. The system according to claim 8, wherein the region of detachment generates a shear layer, and said vortex generator is oriented so as to direct the periodic air jet in or towards the shear layer.

10. The system according to claim 9, wherein the periodic air jet generates vortices, and said vortex generator is oriented so that the vortices move in a predefined direction towards the shear layer so as to propagate the vortices in or towards the shear layer.

11. The system according to claim 1, comprising a bypass system used to evacuate the gases of the exhaust line without passing through the vortex generator.

12. The system according to claim 1, comprising at least one opening adapted to entrain the subframe air by a venturi effect.

13. The system according to claim 1, wherein the bodywork element is a rear bumper.

14. A motor vehicle equipped with an aerodynamic system according to claim 1.
